(19) United States
(12) Patent Application Publication
(10) Pub. No.: US 2002/0000285 A1
(43) Pub. Date: Jan. 3, 2002

(54) RIGID CORRUGATED CARBOARD

(76) Inventor: MICHEL HARRIBEY, ROUTE DU STADE (FR)

Correspondence Address: OBLON SPIVAK MCCLELLAND MAIER & NEUSTADT, 1755 JEFFERSON DAVIS HIGHWAY, FOURTH FLOOR, ARLINGTON, VA, 22202

(21) Appl. No.: 09/147,458

(22) PCT Filed: May 6, 1998
(86) PCT No.: PCT/FR98/00906

(30) Foreign Application Priority Data
May 6, 1997 (FR) 97/05558

(51) Int. Cl. B31F 1/22

(52) U.S. Cl. 156/205

(57) ABSTRACT

The invention relates to a method for manufacturing a rigid corrugated board, comprising, beforehand, a stage for the production of at least one single-faced web of given width by the adhesive bonding of a flute to a single-faced covering.

According to the invention, the following stages are carried out:

a) the single-faced web is bent according to a desired shape,

b) the tops of the flute of the bent single-faced web are coated with glue,

c) at least one double-faced covering of the same width as the single-faced web is adhesively bonded to the said single-faced web in such a way that it matches the bent shape of the said web.

The invention also relates to an apparatus for carrying out the method and to the rigid corrugated board obtained according to the method.

The present invention relates to a method for manufacturing a rigid corrugated board, an apparatus for carrying out the method and a corrugated board obtained by this method.

It applies more particularly to the boards necessary for the manufacture of packages or packaging.

Corrugated board, which is well known to the average person skilled in the art, is a complex material composed of two to seven paper sheets. The sheets are called covering sheets, when they are external, and middle sheets, when they are internal.

The fluted sheets which form the spacers and which are adhesively bonded to the sheets mentioned above are called flutes.

Known corrugated boards may, in fact, be classified in a non-limiting way into two categories:

On the one hand, one type of corrugated board may be likened to a flexible structure. This type of corrugated board is single-faced corrugated board called a single-faced web. This consists of a single-faced covering and of a flute which are fixed together by means of glue spots on the peaks of flutes in contact with the covering.

The advantage of this board is that it can be curved as desired, in particular wound up, without being folded. Moreover, it is stored in rolls and used, in particular, as supporting wedging for various panels.

One disadvantage of this board is that it is not very strong, since, by definition, it is not a profiled sandwich structure. It therefore cannot be employed directly as part of a package and is of limited use.

On the other hand, all the other corrugated boards may be likened to a rigid structure. Mention may be made, for example, of double-faced corrugated board consisting of a flute adhesively bonded and inserted between a single-faced covering and a double-faced covering, or of double-faced corrugated board consisting of two flutes adhesively bonded and inserted between two single-faced coverings and one double-faced covering. As soon as they are manufactured, they are cut into cards and are therefore, by definition, flat. They are strong and can be used as parts of a package, such as a case, the edges of which are resultants of the folding lines of the said boards.

One disadvantage of this type of corrugated board is that, before it can be used as part of a package, it must undergo one or more groovings, this being an operation which involves partially crushing the entire thickness of the corrugated board along a line, in order to make it easier for the flaps subsequently to be folded.

These two categories of corrugated board therefore each have their own closely linked characteristics, namely flexibility and curvature as regards the first of these categories, and rigidity and planeness as regards the second.

The patent application FR 2,668,099 discloses a method for manufacturing a shell having semi-cylindrical cells, which is made from corrugated board and which may therefore be allocated to a third category of corrugated board since it is both rigid and curved. This method involves adhesively bonding a double-faced covering sheet to the flutes of a strip of single-faced corrugated board in a zone where the strip is already bent round a roll. Such a method is advantageous because, since it is carried out continuously on an industrial line, it makes it possible to produce a high output of shells. The shells obtained are inexpensive, light and robust, and they prove very simple to use.

However, the uses of such shells are restricted due to a very special geometry and are confined, for example, to the wedging of cylindrical articles, in particular bottles laid in a packing case.

The object of the present invention is, therefore, to overcome this disadvantage and consequently propose a new method for manufacturing rigid corrugated board which makes it possible, in particular, to obtain new curved shapes.

To achieve this, the subject of the invention is a method for manufacturing a rigid corrugated board, the said method comprising, beforehand, a stage for the production of at least one single-faced web of given width by the adhesive bonding of a flute to a single-faced covering. According to the invention, the following stages are carried out:

a) the single-faced web is bent according to a desired shape,

b) the tops of the flute of the bent single-faced web are coated with glue,

c) at least one double-faced covering of the same width as the single-faced web is adhesively bonded to the said single-faced web in such a way that it matches the bent shape of the said web.

Within the context of the invention, “given width” must be understood as referring to the dimension of the web in the cross direction. Likewise, “bent shape” must be understood as referring to a shape which, seen in section perpendicularly to the tops of the flute, defines a curved surface.

Such a method is very simple to carry out, since it can be employed directly, starting from all the known types of covering, for example made from Kraft liner paper, test liner paper, whatever the basis weight under consideration. It may also be employed, starting from all types of known flutes (semi-chemical, wood, standard, ordinary), whatever the profile under consideration (micro, small, medium, large flute). Finally, adhesive bonding may be carried out, starting from conventional glues of the starch or vinyl type.

Moreover, this method makes it possible to provide packages which, in particular, have small dimensions and are both light and aesthetically attractive. For an equivalent structure, these packages have a highly advantageous mechanical strength/weight ratio, as compared with existing ones which comprise compact board and/or parts of grooved rigid corrugated board.

Finally, according to this method, it is possible to produce directly the wall of a container of the box type, the cross section of which may comprise a multiplicity of concavities facing towards the inside of the cross section and towards the outside alternately. For example, a corrugated-board wall having a rose-shaped cross section may be obtained.

According to a highly advantageous characteristic of the invention, stage a) is carried out by closing the abovementioned single-faced web on itself.

According to this characteristic, the single-faced web has a closed bent shape.

A first variant of the invention involves discontinuously carrying out the cutting of a predetermined length of the single-faced web, before bending the latter.

Preferably, before the adhesive bonding of at least one double-faced covering is carried out, a ratio of the length of the double-faced covering to the length of the single-faced covering is determined, so as to set the superposition of the two coverings relative to one another as well as possible. Thus, an overlap may or may not be provided, the choice of such an overlap being guided by technical considerations (reinforcement of the curved assembly) and/or by considerations of an aesthetic nature.

As regards the cutting of a predetermined length of the single-faced web, advantageously the double-faced covering is cut before or after it is adhesively bonded to the bent single-faced web.

According to another variant of the invention, the assembly of the rigid corrugated board is cut continuously once it has been bent.

In order to produce the container of the box type completely, advantageously the closed rigid corrugated board according to the invention is assembled together with a plane piece, in particular a compact or corrugated board, intended for serving as a bottom. The assembly operation is preferably carried out by mechanical means which are adaptable as a function of the size of the container and of the material of the attached plane piece. The mechanical means may be crimping, adhesive bonding or stapling in the case of bottoms made of plastic or wooden corrugated or compact board.

The invention also proposes an apparatus for carrying out the method. This apparatus comprises:

means for bending the single-faced web,

means for coating with glue the tops of the flute of the bent single-faced web,

means for applying at least one double-faced covering having the same width as the single-faced web to the said bent single-faced web.

Advantageously, the means for bending the single-faced web comprise, furthermore, means for closing the said web on itself.

According to one embodiment, the apparatus comprises a device for cutting a predetermined length of the single-faced web and advantageously comprises a device for cutting the adhesively bonded double-faced covering.

According to another embodiment, the apparatus comprises a device for cutting the bent rigid corrugated board.

According to a preferred variant, the curving means comprise a mould, the surface of which is advantageously put under a vacuum. The single-faced web is thus easily laid against the mould which may be a relatively complex shape.

When the apparatus comprises a mould, the means for applying the double-faced covering to the single-faced web may comprise at least one countermould having a complementary shape in a curving zone.

Here, and in the rest of the text, “curving zone” must be understood as referring to a zone where the concavity faces towards the inside of the mould.

When the curved rigid corrugated board according to the invention is intended to serve as a container, the apparatus may advantageously comprise a device for assembling together with a plane piece intended to serve as a bottom.

Finally, the invention relates to a rigid corrugated board obtained according to the preceding method. This board is characterized in that the minimum radius of curvature of the single-faced web is approximately equal to H-0.5 p, where H and p respectively represent the height and the pitch of the flute.

As mentioned above, the invention makes use, as components, of all the known conventional components and makes it possible to obtain new curved shapes of rigid corrugated boards. These shapes have a structural rigidity which is fully comparable to or even greater than that of the known flat corrugated boards, such as double-faced corrugated board or double/double-faced board.

The corrugated board according to the invention can be used, in particular, as a cask, case, box or wrapping.

Other details and advantageous characteristics of the invention may be gathered below from the detailed description of exemplary embodiments of the invention which is made with reference to the figures of which:

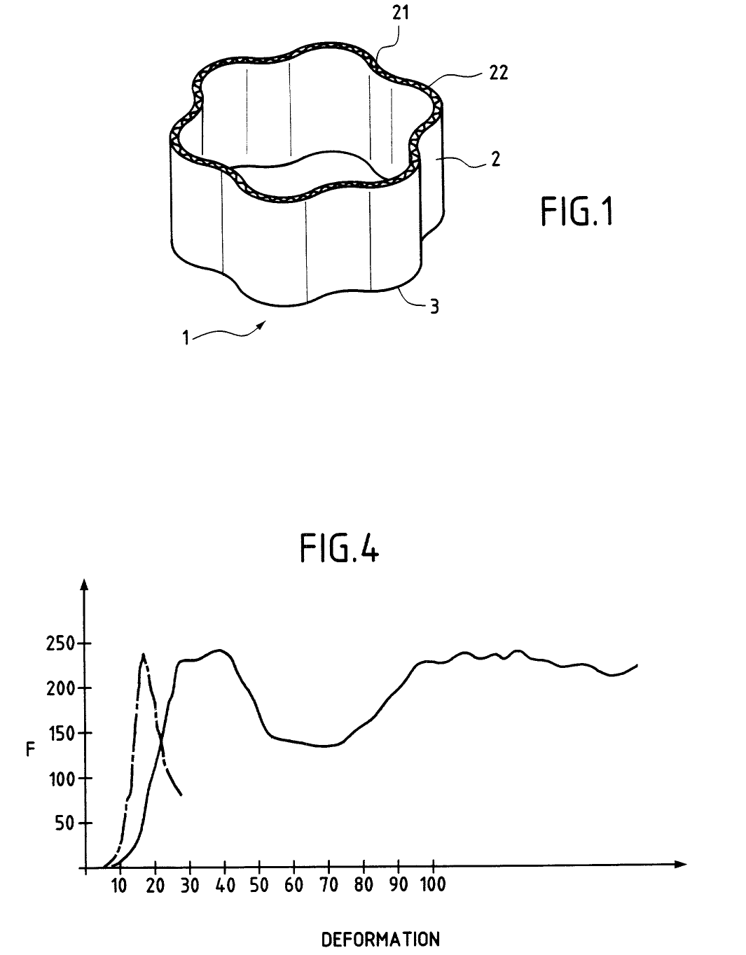

FIG. 1 shows a perspective view of the lower part of a packing box equivalent to the invention.

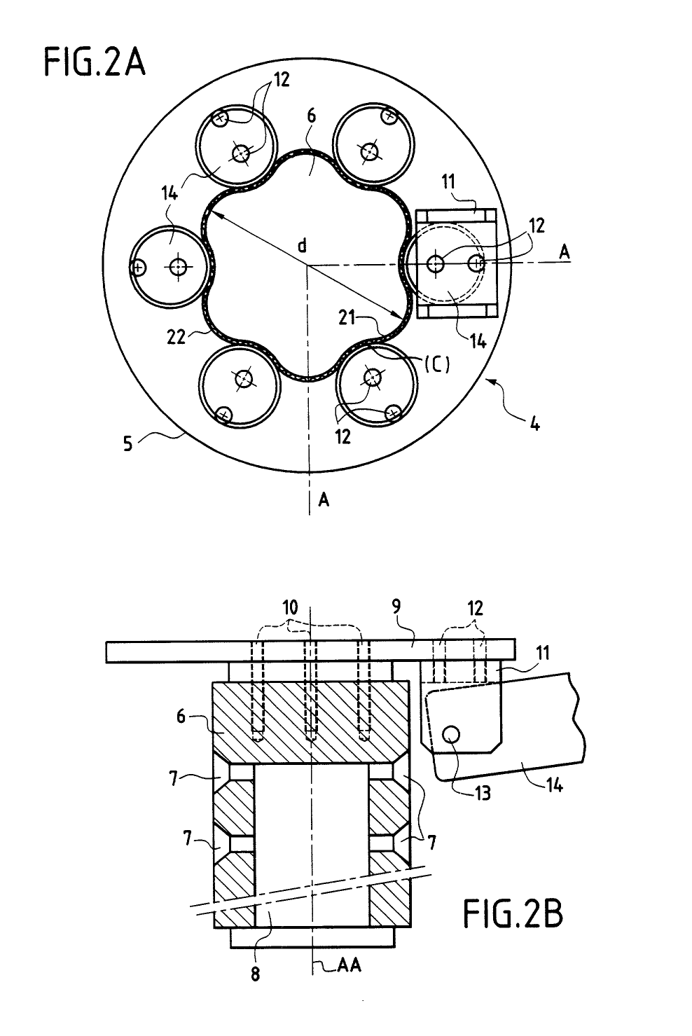

FIGS. 2a and 2b show a general elevation view of a first apparatus according to the invention and a half-sectional view along the line A-A of the same apparatus,

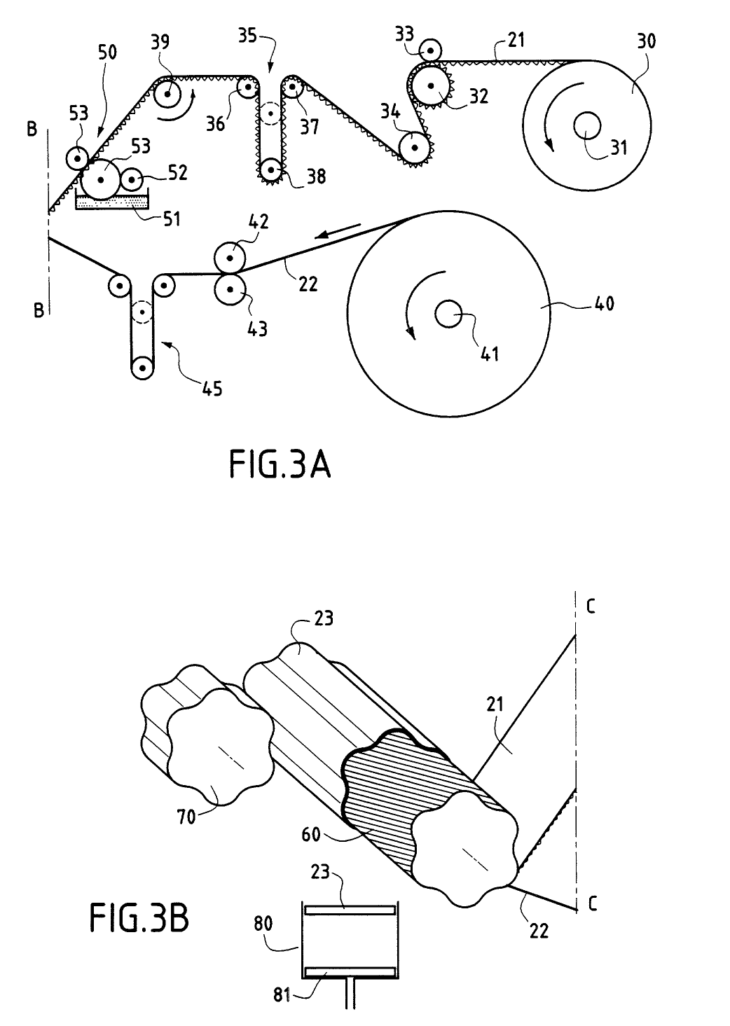

FIGS. 3a and 3b, which are to be joined together, with the lines B-B and C-C being made to coincide, show a general elevation view of a second apparatus according to the invention capable of being used continuously with part of an apparatus for manufacturing double-faced corrugated board.

Referring to FIG. 1, the box 1 has a side wall 2 which has a rose-shaped cross section with a height of 2.9 cm and below which is adhesively bonded a bottom 3 made from a double-faced corrugated board, of which the single-faced covering with a basis weight equal to 140 g/m² is made of white top paper, the E-type flute with a basis weight equal to 140 g/m² is made of bleached kraft paper and the double-faced covering with a basis weight equal to 230 g/m² is made of printed coated white writing paper.

As explained above, the side wall 2 is produced from a single-faced corrugated board 21 which is curved in the form of a rose and to the flute of which a double-faced covering 22 is adhesively bonded.

The coverings and the flute of the side wall 2 have the same characteristics as those of the coverings and the flute of the bottom 3.

The rose comprises twelve concavities facing towards the inside and towards the outside of the box 1 alternately.

One possible use of the box 1 is the packaging of food products, such as cheeses.

The apparatus 4 which made it possible to manufacture the side wall 2 of the box 1 will now be described with reference to FIGS. 2a and 2b.

This apparatus 4 comprises a frame 5, on which is mounted a mould 6 in the form of a sleeve having a height of 1 m and a rose-shaped cross section, the distance which separates two opposite “external” concavities d being equal to 10.1 cm.

This mould 6 is pierced with orifices 7 which open into an inner throat 8 which is extended as far as the frame 5 and which is connected to a device for putting under a vacuum (not illustrated). The shaping of the single-faced web can thus be made easier by this device for putting under a vacuum.

A circular plate 9 is fastened below this mould 6 by means of six screws 10 distributed uniformly on a diameter.

Six shackles 11 are distributed uniformly on the peripheral part of the circular plate 9.

Each shackle 11 is fastened to the circular plate 9 by means of two screws 12 and comprises, in its lower part, a shaft 13, about which a hollow cylinder 14 of a length substantially equal to the height of the sleeve 6 can pivot from a horizontal position to a vertical position in the extension of the shackle 11.

The apparatus 4 also comprises guide studs (not illustrated) located opposite the plate 9 (there being six of these guide studs in FIGS. 2a and 2b) and distributed uniformly on a circumference around the sleeve 6.

These guide studs are intended for engaging simultaneously in the extension of the shackles 11 to a distance equal to 1.5 millimetres of the sleeve 6 when the cylinders 14 are in the horizontal position.

The functioning of the apparatus 4 will now be described in detail.

With the aid of the guide studs engaged in the extension of the shackles 11, a single-faced web 21 of a predetermined length exactly equal to the circumference of the sleeve 6 and of the given width, selected as being substantially equal to the difference between the height of the sleeve 6 and the height of the shackle 11, is positioned around this same sleeve 6.

Once this positioning has been carried out, the device for putting the inner throat 8 under a vacuum can be switched on, and this can cause the outer surface of the sleeve 6 to be put under a vacuum via the orifices 7.

The single-faced web is thereby “laid” against the sleeve 6 and therefore matches the shape of the latter perfectly. The guide studs are then disengaged and a glue-coating device (not illustrated) applies a dry vinyl or starch-based glue to the periphery of the bent single-faced web 21 over its entire height, the device for putting under a vacuum still being active.

Once the glue is well impregnated, the guide studs are reengaged, thus making it possible to run along the sleeve 6, on which the single-faced web 21 is bent, a double-faced covering 22 having identical dimensions to the said web.

In conjunction with the retraction of the guide studs, the cylinders 14 are lowered into the vertical position and, when in contact with the double-faced covering 22, gives the latter the corresponding internal concavities (C).

The device for putting under a vacuum is then deactivated, and the cylinders 14 are maintained into a vertical position for the time necessary for adhesive bonding.

Of course, in order to accelerate the drying of the glue, drying devices, for example by heating, may be provided along the sleeve 6.

Since the complex boarding is dry from now on, it is sufficient for the number of side walls 2 necessary for manufacturing the box 1 to be delivered by cutting into strips. This operation may be carried out, for example, with the aid of an arm which is equipped with a cutting blade and which “sweeps over” the outer surface at such a speed that the blade penetrates tangentially into each curving zone, without the risk of tearing the complex boarding. It may likewise be carried out with the aid of a laser.

It is clear, in this embodiment, that the single-faced web 21 must be cut before being bent. As regards the double-faced covering 22, this may be cut before or after it is adhesively bonded. With the aid of this same apparatus 4, the complex boarding may, of course, be produced, without the vacuum device being switched on. For example, it is possible, first of all, to carry out the glue coating of the double-faced covering 22 and execute the shaping stage solely as a result of contact with the cylinders 14 which exert sufficient mechanical pressure.

FIGS. 3a and 3b, which must be joined together, with the lines B-B and C-C being made to coincide, show a general elevation view of a second apparatus, according to the invention capable of being used continuously with part of an apparatus for manufacturing double-faced corrugated board.

For the sake of clarity and to make understanding easier, that part of the apparatus of FIG. 3b which corresponds to the apparatus according to the invention is illustrated on a larger scale than that of FIG. 3.

There will now be described that part of the apparatus of FIG. 3 which is virtually identical to the upstream part of a machine for manufacturing double-faced corrugated board of the corrugating-train type, that is to say the part located upstream of the glue-coating machine.

This part comprises a reel 30 of a single-faced web of corrugated board 21 and a reel 40 of double-faced covering 22. The single-faced web 21 and the double-faced covering 22 have the same width. The essential difference between this part and an upstream part of a known machine for manufacturing double-faced corrugated board is that the two abovementioned reels 30, 40 are offset relative to one another by approximately half the breadth transversely to the respective unwinding axes 31, 41 of the single-faced web and of the double-faced covering.

The single-faced web 21 is driven by a serrated drum 32 controlled by a variable speed gear and having the axial flutes, into which fit the flutes of the corrugated board. A back-up roller 33 keeps the web in contact with the serrated drum.

The web is subsequently would onto a roller 34 arranged in such a way that the web is applied only over a fraction of a revolution of the drum.

As regards the double-faced web, this is introduced between two drive rollers 42, 43 which are likewise controlled by a variable speed gear.

The respective linear drive speeds of the single-faced web and of the double-faced covering V₁ and V₂ are equal.

In order to avoid any instantaneous fluctuation in these speeds, fluctuation absorption devices or variable tension assemblies 35 and 45 are mounted between the reels 30, 40 and that part of the apparatus which is illustrated in FIG. 3b. Since these assemblies are identical, only one will be described. The variable tension assembly 35 comprises two fixed rollers 36, 37, around which the single-faced web passes, at the same time forming a vertical loop, the end of which is wound onto a freely suspended drum 38. When the instantaneous linear speed of a single-faced web fluctuates, the drum 38 is displaced vertically between a low position and a high position illustrated respectively by unbroken lines and by broken lines in FIG. 3a.

When it leaves the variable tension assembly 35, the single-faced web 21 is subsequently wound onto a servo-drum, the function of which will be explained below, and then passes into a glue-coating device 50 controlled by a drive motor (not shown). This drum must be as light as possible, so that its inertia does not give rise to any excessive acceleration or deceleration effects. It extracts glue from a tank 51 by dipping, the excess being removed by a wiping roller 52. A back-up press roller 53 lays the single-faced web 21 against the glue-coating drum 53. The flutes of the single-faced web are coated with glue in this way.

The servo-drum 39 controls the motor of the glue-coating drum 53, so as to drive it at the same speed as the unwinding speed of the single-faced web.

If this condition were not satisfied, the web would slide on the glue-coating drum and would “wipe off” the glue, without being impregnated with it. Various known servo-systems 39 may be used. For example, the servo-drum may be equipped, on its periphery, with a notched disc of small width, which meshes in the flutes of the web and which is therefore driven at a speed perfectly in synchronism with that of the web. This disc drives an optical encoder which supplies the servo-frequency intended for controlling the drive motor of the glue-coating drum.

In FIG. 3b, it can be seen that the single-faced web, thus coated with glue, and the double-faced covering engage in an offset manner on the sleeve 6 having a rose-shaped cross section and identical to that illustrated in FIGS. 2a and 2b.

The axis of this sleeve 6 is inclined and forms an angle α with the unwinding axis of the single-faced web and of the double-faced covering and rotates at a speed corresponding to the abovementioned linear drive speeds V₁ and V₂ with the aid of a variable speed motor (not shown) located on the reader's side. The angle α is, at all events, sufficiently small to allow the singe-faced web 21 to be positioned edge to edge during each revolution executed by the sleeve 6.

The angle of inclination α of the sleeve 6 may, of course, be different, provided that it remains within limits such that the extensibility limit of the single-faced web 21 is not reached. Moreover, it also depends on the amount of transverse offset selected between the two reels of components of the corrugated board.

Whatever the type of components used to manufacture the single-faced web 21, this angle of inclination, which is therefore equal to the angle formed by the line of the tops of the flute and the axis of rotation of the sleeve 6, must be lower than or equal to 45°.

Furthermore, this sleeve 6 is provided, for its entire extent, with a multiplicity of orifices (not shown)identical to the orifices 11 of FIG. 2a.

The orifices open into a throat of a cylindrical type which is itself connected to a vacuum device of the vacuum-pump type (not illustrated) which is located on the reader's side and which therefore “lays” the single-faced web 21 against the sleeve 6.

It should be noted, here, that the vacuum is, at all events, sufficiently low to make it possible for the single-faced web 21 to “run over” the sleeve 6, at the same time forming a helix 60.

This helix 60 is covered with the double-faced covering 22, which is therefore laid onto it and adhesively bonded to it, once the “offset” has been compensated by means (not shown). These means are mechanical, of the roller type, the shape of which is exactly complementary to that of the concavities of the sleeve 6, and/or pneumatic means of the type comprising a chamber put under pressure.

Drying devices (not illustrated), for example using electrical heating, are provided along the sleeve and thus make it easier to dry this complex boarding formed in this way.

In the end part of the sleeve, the complex enters a rotary shearing device 70 having a shape exactly complemetary to the sleeve and consisting, for example, of a hard-steel blade intended for shearing the complex boarding into a plurality of straight lateral strips 23, each having a width equal to the side wall 2 of the box 1 to be manufactured, such as that illustrated in FIG. 1.

Of course, in order to ensure cutting into straight parallel strips, the axis of the shearing device must itself be exactly parallel to the axis of rotation of the sleeve 6 and have the same linear speed as the unwinding speed of the single-faced web.

Advantageously, just as in the apparatus of FIGS. 2a and 2b, cutting with the aid of a laser may be provided.

The boarded lateral strips 23 cut in this way are disengaged from the sleeve 6 and are stacked in crates 80 having a movable bottom 81 and located in the background. The manufacture of a box 2 according to the invention is completed by an operation to bond a lateral strip adhesively to a bottom.

For this operation, there is provision, for example, for delivering lateral strips via the movable bottom 81 of the crates 80, the said bottom being connected to an endless band conveyor, on tables above which are placed bottoms 3 which are made of double-faced corrugated board and the peripheral edges of which are coated with glue. For this operation, provision may also be made for a bottom 3 and a lateral strip 23, the edges of which are coated with glue, to be positioned successively and assembled together in this way.

The sleeves of the two apparatuses according to the invention which have just been described may, of course, take various forms, such as a cylindrical sleeve or a sleeve with an ellipsoidal base, the length of the sleeve being necessarily greater than the width of the single-faced web.

Where the second apparatus is concerned, synchronization between the speed of rotation and the respective linear unwinding speeds of the single-faced web and of the double-faced covering is an important element which it is essential to control, otherwise the complex boarding does not have the desired shape and, even worse, its manufacture is doomed to failure.

Likewise, where this second apparatus according to the invention is concerned, when the sleeve does not have a concave shape facing towards the outside of the sleeve, for example with regard to a cylinder, there is no need to have means for putting the sleeve under a vacuum and/or means for laying the double face 22 onto the sleeve.

In fact, the mere tension of both the single-faced web 21 and the double-faced covering 22 is sufficient to keep the complex boarding “laid” against the sleeve 6.

The manufacturing apparatus described above make it possible to have access to packages, particularly of small dimension, which are aesthetically attractive, light and robust.

This last characteristic is revealed particularly clearly by the comparative curves of FIG. 4. These are obtained from a crushing test which makes it possible to measure the edge compression resistance parallel to the edge of the flute and thus makes it possible to assess dynamic compression.

The tests were conducted with the aid of a device of the compressometer type from the company L&W, which comprises two plates approaching one another at a constant speed perpendicularly to the flute.

The measurement of the crush resistance then involves recording the force, measured in daN, provided by the plates as a function of the deformation of the test piece placed between these plates, measured in millimetres.

The curve represented by a broken line in FIG. 4 relates to a wall of rectangular cross section with a height of 130 mm, a length of 180 mm and a width of 75 mm, made from flat double corrugated board which has been grooved and then glued, using a vinyl glue, as a comparative example.

This flat double-faced corrugated board comprises a single-faced web, of which the single-faced covering with a basis weight equal to 150 g/m², made of kraft paper, is combined with a C-type flute with a basis weight equal to 120 g/m², made of VP paper, and a double-faced covering with a basis weight equal to 200 g/m², made of kraft paper. The curve represented by a continuous line in FIG. 4 relates to a cylinder of corrugated cardboard produced according to the invention, with a height of 130 mm and a diameter equal to 165 mm, adhesive bonding likewise having been carried out, using a vinyl glue. The characteristics of the components of this board are strictly identical to those defined above.

The weight of the two boards is substantially identical and is equal to 38.2 g.

If the two curves are compared, it can be seen clearly that the mode of deformation is not the same at all for a grooved double-faced corrugated board and a closed corrugated board which is the subject of the invention.

If elastic limits are substantially identical, the breaking of the board by buckling is avoided absolutely in the case of the specific structure according to the invention and there is therefore some “damping” effect in addition to much greater toughness.

It may therefore be concluded that, for an identical weight, the long-term resistance under stress ensures that a package of given capacity has a higher performance if it is manufactured according to the invention.

In other words, where stacking is concerned, the packages according to the invention will tend, in the event of an excessive load, to subside progressively instead of giving way suddenly, this being advantageous when the fragile and costly contents, for example perishable foodstuffs, are to be recovered, before being crushed.

It goes without saying that many modifications of details may be made to the method, to the apparatuses and to the boards obtained which have been described, without thereby departing from the scope of the invention. For example, instead of coating the flutes of the single-faced web with glue, the double-faced covering sheet may just as well be coated with glue.

Likewise, instead of bending the single-faced web, the double-faced covering sheet may just as well be bent.

Finally, instead of lining the double-faced covering, one or more single-faced webs may similarly be lined.

1. Method for manufacturing a rigid corrugated board (2), comprising, beforehand, a stage for the production of at least one single-faced web (21) of given width by the adhesive bonding of a flute to a single-faced covering, characterized in that the following stages are carried out:
a) the single-faced web (21) is bent according to a desired shape,
b) the tops of the flute of the bent single-faced web (21) are coated with glue,
c) at least one double-faced covering (22) of the same width as the single-faced web is adhesively bonded to the said single-faced web (21) in such a way that it matches the bent shape of the said web.

2. Method according to claim 1, characterized in that stage a) is carried out by closing the single-faced web (21) on itself.

3. Method according to claim 1 or 2, characterized in that a predetermined length of the single-faced web (21) is cut before the said web is bent.

4. Method according to one of claims 1 to 3, characterized in that, before the adhesive bonding of at least one double-faced covering (22) is carried out, a ratio of the length of the double-faced covering to the length of the single-faced covering is determined, so as to set the superposition of the two coverings relative to one another as well as possible.

5. Method according to one of the preceding claims, characterized in that the said double-faced covering (22) is cut before or after it is adhesively bonded to the bent single-faced web (21).

6. Method according to claim 1, characterized in that the single-faced web (21) is bent by being deformed in such a way that the angle α formed by the direction of the said bent desired shape and the line of the tops of the flute is between 0 and 45°.

7. Method according to one of claims 1 or 6, characterized in that the rigid corrugated board (2) is cut once it has been bent.

8. Method according to one of claims 2 to 5, characterized in that the bent and closed rigid corrugated board (2) is assembled together with a plane piece (3), in particular of corrugated board, so as to produce a container of the box type (1).

9. Method according to claim 8, characterized in that assembling together is carried out by crimping, adhesive bonding or stapling.

10. Apparatus (4) for carrying out the method according to one of the preceding claims, characterized in that it comprises:
means (6, 14) for bending the single-faced web (21),
means (50) for coating the tops of the flute of the bent single-faced web with glue,
means (14) for applying at least one double-faced covering (22) of the same width as the single-faced web to the said bent single-faced web.

11. Apparatus according to claim 10, characterized in that the means (6, 14) for bending the single-faced web (21) comprises, furthermore, means for closing the said web on itself.

12. Apparatus according to claim 10 or 11, characterized in that it comprises, furthermore, a device for cutting a predetermined length of a single-faced web (21).

13. Apparatus according to one of claims 10 to 12, characterized in that it comprises a device for cutting the adhesively bonded double-faced covering (22).

14. Apparatus according to claim 10, characterized in that it comprises a device (70) for cutting the bent rigid corrugated board (2).

15. Apparatus according to one of claims 10 to 14, characterized in that the curving means comprise a mould (6).

16. Apparatus according to claim 15, characterized in that it comprises means (7, 8) for putting the surface of the mould under a vacuum.

17. Apparatus according to one of claims 10 to 16, characterized in that the means for applying the double-faced covering to the single-faced web comprise at least one countermould having a complementary shape in a curving zone.

18. Apparatus according to one of claims 11 to 17, characterized in that it comprises a device for assembling the closed rigid corrugated board (2) together with a plane piece (3), particularly of corrugated board, so as to produce a container of the box type (1).

19. Rigid corrugated board (2), characterized in that it is obtained in conformity with the method according to one of claims 1 to 9.

20. Board according to claim 19, characterized in that the minimum distance between the peak and valley of a corrugation of the flute dₘᵢₙ is approximately equal to H-0.5p, where H and p respectively represent the height and the pitch of the said flute.

21. Use of a corrugated board according to claim 19 or 20 as a cask, case, box or wrapping.
